(19) United States
(12) Patent Application Publication
(10) Pub. No.: US 2020/0338808 A1
(43) Pub. Date: Oct. 29, 2020

(54) THIN FILM WITH HIGH GRIP MICROFEATURES

(71) Applicant: Hoowaki, LLC, Greenville, SC (US)

(72) Inventors: Ralph A. Hulseman, Greenville, SC (US); Cameron McPherson, Easley, SC (US); Nakul Ravikumar, Greenville, SC (US)

(21) Appl. No.: 16/392,297

(22) Filed: Apr. 23, 2019

(51) Int. Cl. B29C 59/02

(52) U.S. Cl. CPC B29C 59/022; B29L 2007/008; B29C 2059/023

(57) ABSTRACT

A polymer film having an initial thickness of 20 to 200 microns. A two-level micro pattern formed on at least one side of the film so that the polymer film has a base thickness less than the initial thickness of the film following the addition of the two-level micro pattern. A plurality of microfeatures defining the micro pattern wherein a height of the microfeatures on the film is in a range from about 0.3 to about 4 times the initial film thickness while maintaining the structural stability of the microfeatures to resist bending and provide increased grip against biological tissue and simultaneously providing reduced friction against dry hard plastic and metal surfaces.

### BACKGROUND OF THE INVENTION

### 1) Field of the Invention

The present invention relates to a novel grip, anchoring and anti-migration device consisting of a thin film with microfeatures formed on the surface of the film that creates high grip on biological tissue, while simultaneously having a low co-efficient of friction against dry hard plastic and metal surfaces facilitating the introduction of a device with the high grip film inside the body.

### 2) Description of Related Art

Medical devices are required to become smaller to provide treatment to more areas of the body such as within smaller arteries or veins; within the brain; within the gastrointestinal tract of an infant; or within the inner ear. Devices, such as self-expanding stents and implanted films are required to grip and anchor in place. However, the space available is quite limited and geometrical shapes may be complicated. This means the devices must be quite thin. Films and tubing used as coverings for stents or leads may be as thin as 20 to 100 microns. Currently, they have surfaces that are quite slippery against biological tissue. Anchoring these thin devices in place to eliminate migration has proven difficult. Traditional mechanisms such as sutures are difficult to apply in tights spaces and cause trauma to the tissue. Hooks or barbs are difficult to make small, become ineffective when very small and can lead to tissue trauma.

Polymer films with thicknesses in the range of 10 to 500 microns are usually fabricated via an extrusion line to achieve the desired thickness. Extrusion dies or rolls often have a smooth surface and to produce a smooth film, or they made have a pattern made by machining, engraving or lithographic techniques. These techniques produce a surface with features ranging in size from tens of nanometers to several millimeters.

A present practice in the production of thin polymer film for packaging purposes is blown film extrusion. This involves the extrusion of molten polymer through a die followed by repetitive inflation of the initial diameter to form a thin film bubble. The bubble is then used to make bags or laid down to be used as flat sheets of film.

Another procedure is the use of the cast film process which can produce a thin sheet of film. The polymer is extruded through a slot or flat die to form a thin molten sheet which is “pinned” to the surface of a chill roll using an air knife or vacuum box. A metal shim with micro-features can be added to the existing roll to produce film with single level micro-features as small as several hundred nanometers.

In a further procedure to produce a microfeatures on the film, the roll is modified either by chemical etching, lithography or UV cure technique to imprint the negative pattern of the micro surface on the roll.

Another practice is the stamping of single level micro pattern on thin sheets of pre-extruded polymer film using a hot embossing process. The microfeatures are imprinted on the surface of a polymer film which is softened by raising its temperature just above its glass transition temperature. The stamp with the micro pattern can be made in a variety of materials including silicone, plastic or metal.

In a further practice, elastomeric films of thicknesses down to 50 microns are manufactured by spin-coating a polymer onto the surface of a silicon wafer and then manually peeling the film after curing. It has many drawbacks such as it is labor-intensive and suffers from low yield, dimensional inaccuracies, tearing and wrinkling.

All of the above-mentioned techniques are capable of producing thin polymer film without pattern or with a pattern in a specific size range. However, the thickness of the base material made by these processes is always greater than the microfeature height if the base thickness is less than about 200 microns thick and if the microfeatures have a height less than about 200 microns tall. Thus, the ratio of total height of microfeatures to base thickness is less than or equal to one.

With regards to enhanced grip on polymer film, the current products available are in much bigger size scale. For example, 3M sells “Gripping Material” to provide grip. This product is 1 to 3 millimeters in thickness and the ratio of height of features to base thickness is either equal to or greater than 1. However, this is too much material volume for use in medical procedures, where a starting initial thickness of the film needs to be as thin as 20 to 100 microns.

Two-level microfeatures with high grip require very low contact percentage of the microfeatures as described in previous patents US20180043546A1 and US20190062155A1, which are incorporated herein by reference in their entirety. To achieve the required low contact percentage the features need to have very low surface area that makes contact with the substrate. However, these small features are not stable by themselves and fall over if the aspect ratio of the height of the features relative to the thickness of the substrate exceeds 1, typically between a ratio of 1 to 5 depending on the stiffness of the material. To maintain the structural stability of the small microfeatures, a base level feature is required to carry the smaller microfeatures which is at least twice as big as the smaller microfeatures. Thus, to achieve high grip, two-level features are required as geometrically it is not possible with single level features in soft polymeric materials of the type used in medical devices.

The medical industry has a variety of devices and implants which require grip. These devices may need to grip human skin or other human tissue inside the body in dry, wet or slippery conditions. Currently, there is a lot of research being carried out to prevent migration of implants inside the body or to prevent relative motion between two organs or to just provide a barrier to help healing of tissue. These are just a few examples, but the need for grip is vital under lubricated conditions. These devices are generally inserted through small introducer tubes and thus often need to be collapsible to a small volume.

Accordingly, it is an object of the present invention to provide a novel and simplified technique to form two-level microfeatures on one or both sides of a thin film with an initial thickness as small as about 20 microns. The two-level microfeatures on thin polymer film are fabricated such that the ratio of total microfeature height to initial base thickness of the polymer film is in the range of about 0.3 to about 4 times where the initial film thickness is in the range of 20 to 200 microns.

It is a further object of the present invention to maintain the same volume of the polymer film before and after forming of microfeatures while providing microfeatures taller than the initial thickness of the film to maintain the structural stability and high grip function of the microfeatures.

It is a further object of the present invention to provide a high grip surface which has 2 to 12 times more grip force on biological tissue than an untreated film of the same volume and initial thickness.

Another object of the present invention is to provide a thin film having microfeatures with high grip on wet tissue for many medical applications which require grip inside the body, and wherein the gripping device is small and with the least volume possible for maintaining the structural stability and function of the microfeatures in order to be introduced into the human body with minimal incision.

Another object of the invention is to form microfeatures on the surface of a 20 to 50 micron thick resorbable film which is intended to provide grip inside the body for a specified time.

A further object of the invention is to form microfeatures on a thin polymer film that have low co-efficient of friction against dry hard plastic and metal surfaces, such as the inner surface of introducer, catheter or other medical device, thus facilitating the introduction of the device with the high grip film inside the body.

### SUMMARY OF THE INVENTION

The above objectives are accomplished according to the present invention by providing a thin film having microfeatures comprised of a polymer film having an initial thickness of 20 to 200 microns; a two-level micro pattern formed on at least one side of said film so that said polymer film has a base thickness less than said initial thickness of said film following the addition of said two-level micro pattern; and, a plurality of microfeatures defining said micro pattern wherein a height of said microfeatures on said film is in a range from about 0.3 to about 4 times said initial film thickness.

In a further embodiment, a volume of said polymer film before and after the addition of said two-level micro pattern is approximately the same while having microfeatures taller than the initial thickness of said polymer film.

In a further embodiment, said polymer film is selected from the group consisting of a thermoset and a thermoplastic.

In a further embodiment, said polymer film is selected from the group consisting of polylactide (PLA), acrylic, polyester, polypropylene (PP), polystyrene, nylon, epoxy, silicone, polyurethane (TPU), phenolic, polyester terephthalate (PET), polytetrafluoroethylene(PTFE), high density polyethylene (HDPE), silicone rubber, isoprene rubber, polyurethane rubber, polyethylene (PE), polyacetal resin (POM), and silicone rubber.

In a further embodiment, said polymer film has a modulus ranging from 30 Shore A to 55 Shore D.

In a further embodiment, a lateral friction force of said polymer film is increased at least about 2 times compared to a smooth film of the same initial thickness when measured against wet biological tissue.

In a further embodiment, a lateral friction force of said polymer film is increased about 12 times compared to a smooth film of the same initial thickness when measured against wet biological tissue.

In a further embodiment, said polymer film produces a lateral friction force of up to about 60 Newtons when measured against wet biological tissue.

In a further embodiment, a lateral friction force of said polymer film is decreased in a range of about 20% to about 80% compared to a smooth film of the same initial thickness when measured against a dry, smooth hard plastic.

In a further embodiment, a lateral friction force of said polymer film is decreased in a range of about 20% to about 80% compared to a smooth film of the same initial thickness when measured against a dry, smooth metal surface.

In a further embodiment, a lateral friction force of said polymer film is increased at least about 2 times compared to a smooth film of the same initial thickness when measured against an oily, smooth plastic surface.

In a further embodiment, a lateral friction force of said polymer film is increased at least about 2 times compared to a smooth film of the same initial thickness when measured against an oily, smooth steel surface.

In a further embodiment, a tensile strength of said polymer film is approximately equal to the tensile strength of a smooth film of the same initial thickness.

In a further embodiment, said polymer sheet has an initial thickness of about 20 to about 30 microns and base thickness after forming of said microfeatures of about 10 to about 15 microns, and microfeatures with a height of about 70 microns.

In a further embodiment, a first level of said microfeatures of said two-level micro pattern have a pitch in the range of about 190 microns to about 210 microns, a width in the range of about 90 microns to about 110 microns, and a height of about 45 microns to about 65 microns.

In a further embodiment, a second level of said microfeatures are formed on said first level of said microfeatures and have a pitch in the range of about 15 microns to about 25 microns, a width in the range of about 5 microns to about 15 microns, and a height of about 5 microns to about 20 microns.

In a further embodiment, said microfeatures have a contact percentage with a surface of between about 1% to about 7%.

The above objectives are further accomplished according to the present invention by providing a thin film having microfeatures comprised of a polymer film having an initial thickness of 20 to 200 microns; a two-level micro pattern formed on a top side and a bottom side of said film so that said polymer film has a base thickness less than said initial thickness of said film following the addition of said two-level micro pattern; and, a plurality of microfeatures defining said micro pattern wherein a ratio of a height of said microfeatures to said initial thickness of said film is greater than about 1 while maintaining a structural stability of said microfeatures to resist bending and providing increased grip against biological tissue and simultaneously providing reduced friction against dry hard plastic and metal surfaces.

The above objectives are further accomplished according to the present invention by providing a method of molding microfeatures onto a thin film comprising the steps of: a) providing a silicone mold with a desired micro pattern; b) applying a polymer film to a pattern side of said silicone mold; c) applying a silicone backer over said polymer film on said silicone mold; d) placing pads on said silicone mold and said silicone backer to form a mold package to facilitate even pressure and temperature distribution; e) placing said mold package between heated press plates; f) applying pressure and temperature to reach a melting point of said polymer film; g) maintaining pressure while cooling to room temperature; and, h) removing said polymer film from said mold package; wherein said polymer film has an initial thickness of 20 to 200 microns; wherein a two-level micro pattern is formed on at least one side of said film so that said polymer film has a base thickness less than said initial thickness of said film following the addition of said two-level micro pattern; and, wherein a plurality of microfeatures defining said micro pattern have a height in a range from about 0.3 to about 4 times said initial film thickness.

### BRIEF DESCRIPTION OF THE DRAWINGS

The system designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a top view of the thin film having microfeatures according to the present invention;

FIG. 2 shows a side view of the thin film having microfeatures according to the present invention;

FIG. 3 shows a top perspective view of the thin film having microfeatures according to the present invention;

FIG. 4A shows a cross-sectional view of an initial film thickness prior to microfeatures being formed thereon according to the present invention;

FIG. 4B shows a top view of a portion of the film with the addition of a single two-level microfeature formed on the film;

FIG. 4C shows a cross-sectional view of a portion of the film with the addition of a single two-level microfeature formed on the film such that the base thickness of the film is less than the initial thickness of the film shown in FIG. 4A;

FIG. 5 shows a cross-sectional view of a portion of the film with the addition of a two-level microfeature formed on both a top side and a bottom side of the film such that the base thickness of the film is less than the initial thickness of the film shown in FIG. 4A;

FIGS. 6A and 6B show top view microscopic images at 50 micron scale of a PLA film with microfeatures according to the present invention;

FIGS. 7A and 7B show top view microscopic images at 200 micron scale of a PLA film with microfeatures according to the present invention;

FIGS. 8A and 8B show cross-sectional view microscopic images of a one-sided PLA film with microfeatures according to the present invention;

FIGS. 9A and 9B show cross-sectional view microscopic images of a two-sided PLA film with microfeatures according to the present invention;

FIGS. 10A and 10B show cross-sectional view microscopic images of a one-sided TPU film with microfeatures according to the present invention;

FIGS. 11A and 11B show cross-sectional view microscopic images of a two-sided TPU film with microfeatures according to the present invention; and,

FIG. 12 is a schematic exploded view showing one entire mold package according to the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

The present invention comprises two-level microfeatures on one or both sides of a thin sheet of polymer film where the height of the microfeatures are more than the initial thickness of the film, while maintaining a structural stability of the microfeatures to resist bending and providing increased grip against biological tissue and simultaneously providing reduced friction against dry hard plastic and metal surfaces. Unlike current film products in the industry with microfeatures that are one level with the height to initial thickness ratio less than or equal to one, this invention can be used to fabricate taller microfeatures on thin film to achieve a ratio great than 1.

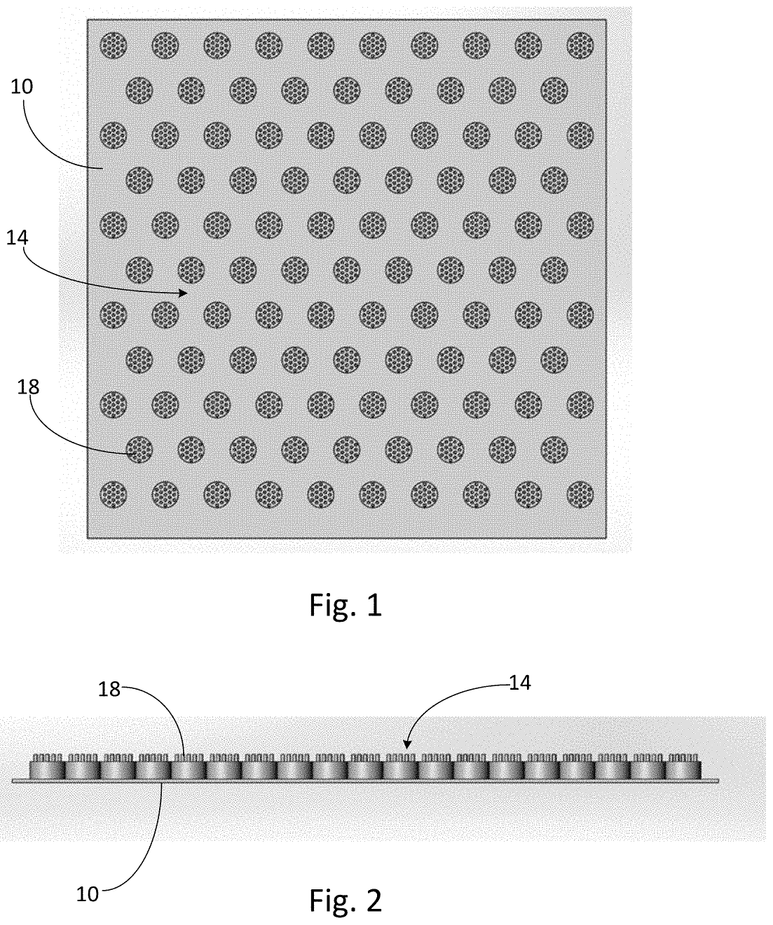

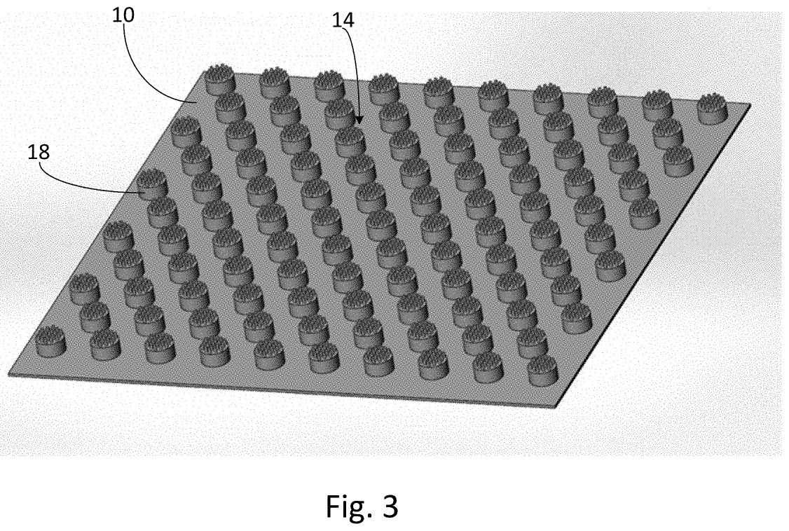

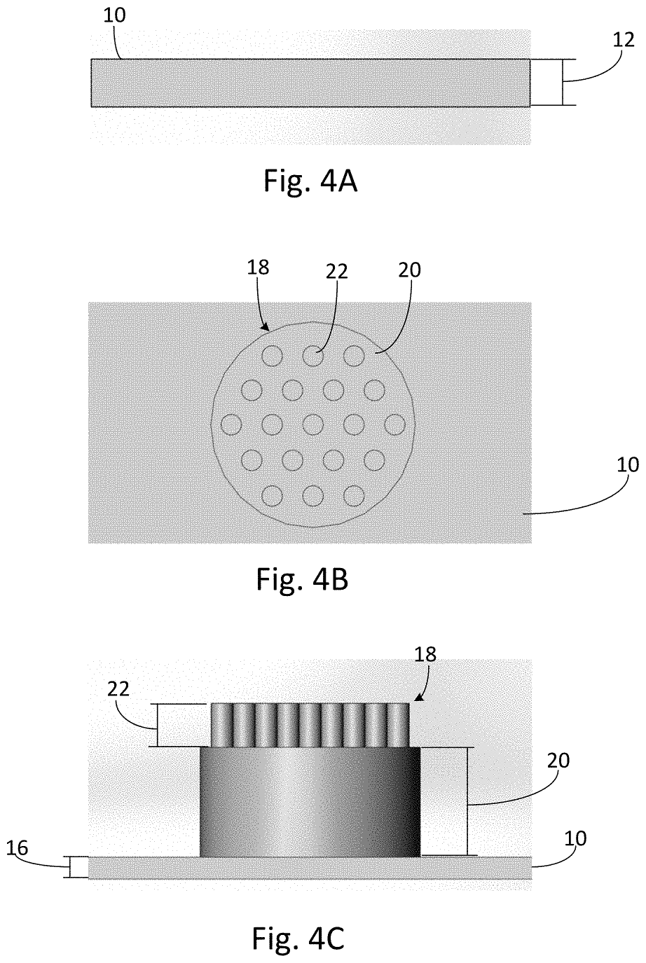

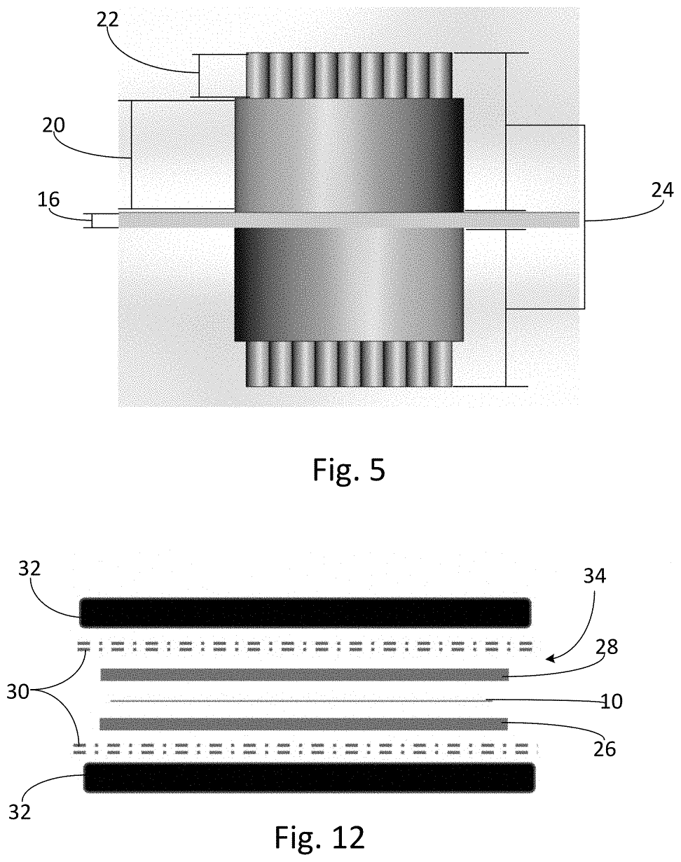

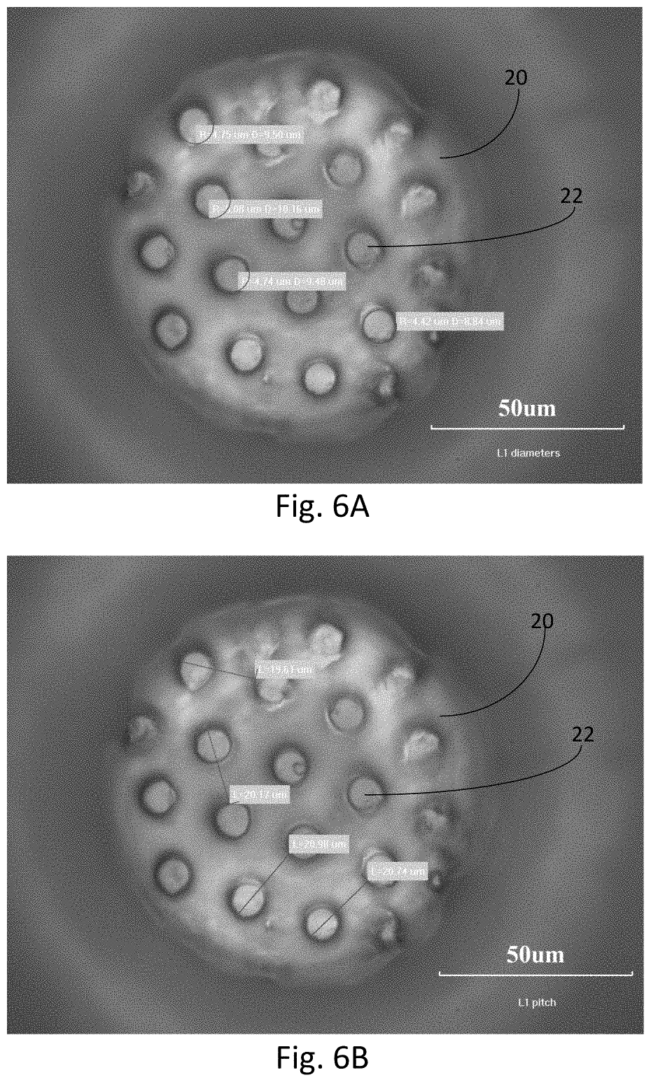

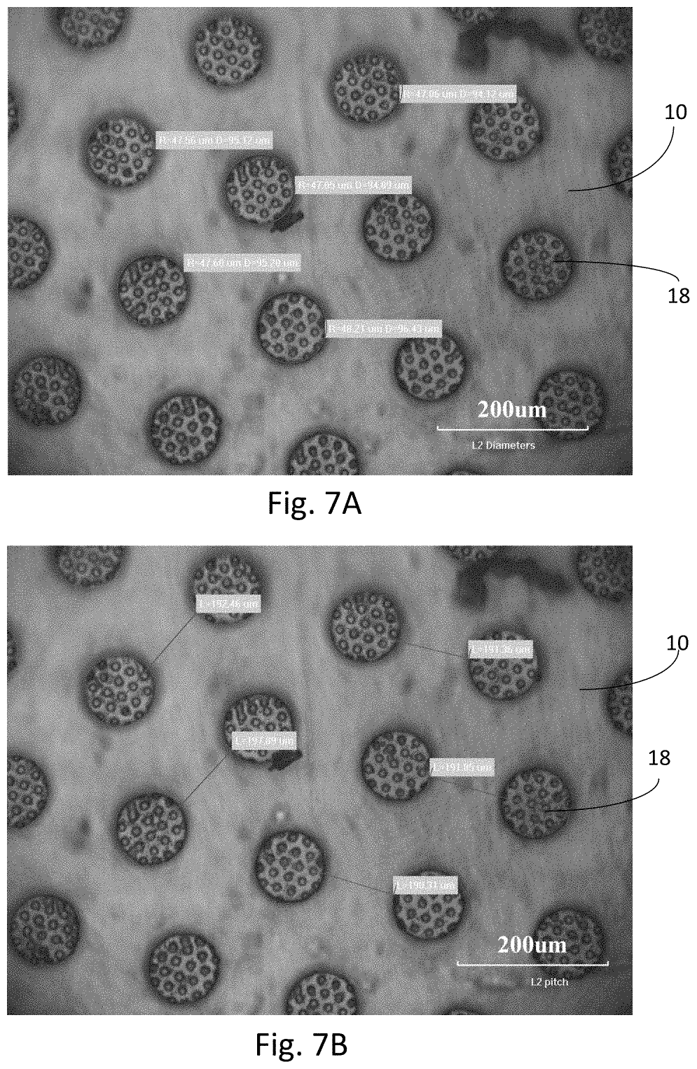

Referring to FIGS. 1 through 7B, a polymer film 10 is provided having an initial thickness 12 (FIG. 4A) of 20 to 200 microns. As best shown in FIGS. 1-3, a two-level micro pattern, designated generally as 14, is formed on at least one side of polymer film 10. As best shown in FIGS. 4A, 4C and 5, polymer film 10 has a final base thickness 16 less than the initial thickness 12 of polymer film 10 following the addition of the two-level micro pattern 14. A plurality of microfeatures 18 define micro pattern 14 wherein a height of the microfeatures on the film is in a range from about 0.3 to about 4 times the initial film thickness 12.

The first level 20 of the microfeatures 18 of the two-level micro pattern 14 have a pitch in the range of about 190 microns to about 210 microns, a width in the range of about 90 microns to about 110 microns, and a height of about 45 microns to about 65 microns.

The second level 22 of the microfeatures 18 are formed on the first level 20 of the microfeatures and have a pitch in the range of about 15 microns to about 25 microns, a width in the range of about 5 microns to about 15 microns, and a height of about 5 microns to about 20 microns. In one embodiment, a total height of the first and second level microfeatures 24 is in the range of about 130-140 microns.

To provide a high grip function, the microfeatures have a contact percentage with a surface of between about 1% to about 7%.

TABLE 1
Film measurements and calculated ratios, measured in microns.

| | | | | | | | Ratio |
|---|---|---|---|---|---|---|---|
| | | | Final | | | | (Total |
| | | Initial | film | | | | feature |
| | | film | base | L1 | L2 | Total | height to |
| Film | | thick- | thick- | feature | feature | feature | initial film |
| Type | Material | ness | ness | height | height | height | thickness) |
| 1 | PLA | 30 | 15 ± | 8 ± | 55 ± | 65 ± | 2.2 ± |
| sided | | | 5 | 3 | 5 | 5 | 0.2 |
| 2 | PLA | 35 | 10 ± | 10 ± | 55 ± | 135 ± | 3.8 ± |
| sided | | | 5 | 3 | 5 | 5 | 0.2 |
| 1 | TPU | 150 | 125 ± | 12 ± | 50 ± | 65 ± | 0.44 ± |
| sided | | | 5 | 3 | 5 | 5 | 0.02 |
| 2 | TPU | 150 | 115 ± | 8 ± | 55 ± | 135 ± | 0.9 ± |
| sided | | | 5 | 3 | 5 | 5 | 0.05 |

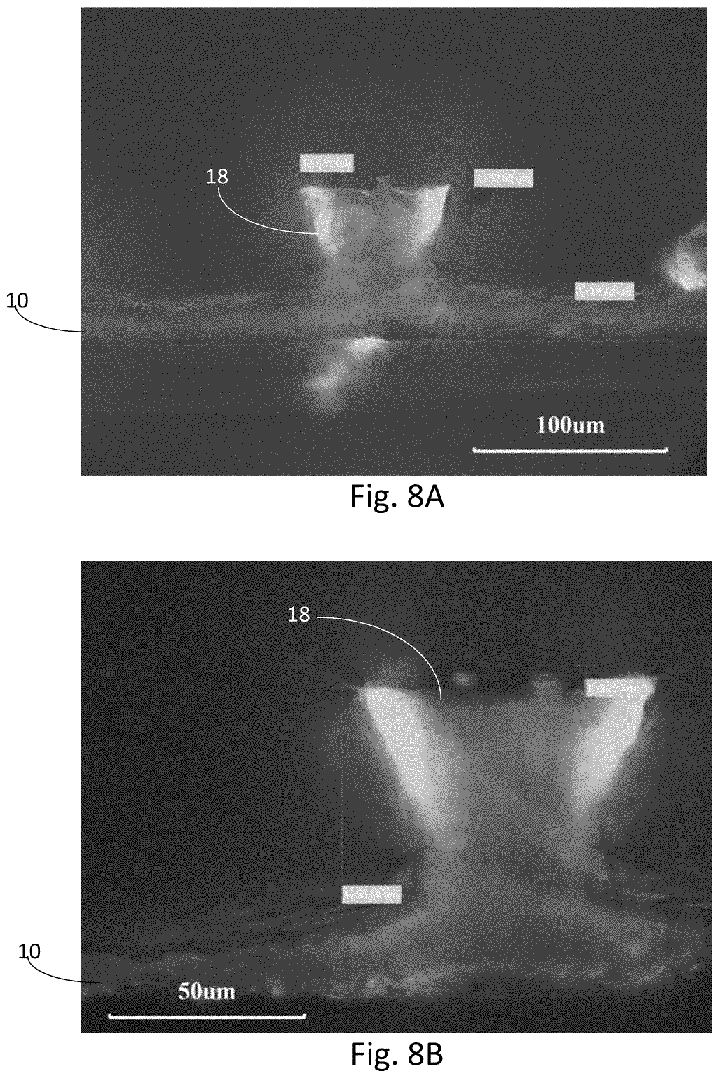

Referring to Table 1 and FIGS. 8A and 8B, in one embodiment of the present invention, 30 micron initial thickness PLA film was fabricated with two-level microfeatures having a base thickness after forming the microfeatures of between 15 to 20 microns with microfeatures having a total height of about 65 microns on a one sided film to produce a ratio of total feature height to initial thickness of the film of about 2. As shown in Table 1, a two sided PLA film having an initial thickness of 35 microns results in a base thickness of about 10 microns with microfeatures having a total height of about 135 microns to produce a ratio of total feature height to initial thickness of the film of about 4.

Another embodiment of the present invention is the ability of this thin PLA film when wet to produce higher grip than a smooth film with the same initial thickness. The grip testing conducted against human skin and chicken leg muscle showed grip values as high as 60 N when compared to a smooth sample with 5 N force. A chicken leg muscle (without skin) was hooked onto a force gauge and saline was sprayed to keep the tissue moist. Film samples with and without microfeatures were placed on the chicken leg muscle and pulled. This testing was repeated three times and grip forces were tabulated in Table 2 below.

TABLE 2
Wet grip testing results of thin PLA film with microfeatures
against human skin and chicken leg muscle.

| | | | | | | Avg. | | Improve- |
|---|---|---|---|---|---|---|---|---|
| | | | | | | Wet | | ment in |
| | Made | | Trial | Trial | Trial | Grip | Std. | Grip |
| Pattern | in | Against | 1 | 2 | 3 | Force | Dev. | Force |
| Smooth | PLA | Chicken | 5.2 | 4 | 5.4 | 4.87 | 0.8 | 1.0 |
| | | leg | | | | | | |
| | | muscle | | | | | | |
| H160CP | PLA | Chicken | 57.8 | 56.6 | 60.8 | 58.40 | 2.2 | 12.0 |
| | | leg | | | | | | |
| | | muscle | | | | | | |
| Smooth | PLA | Human | 4 | 3.6 | 4.4 | 4.00 | 0.4 | 1.0 |
| | | Skin | | | | | | |
| H160CP | PLA | Human | 18.4 | 20.4 | 23 | 20.60 | 2.3 | 5.2 |

| | |
|---|---|
| Skin | Force in N |

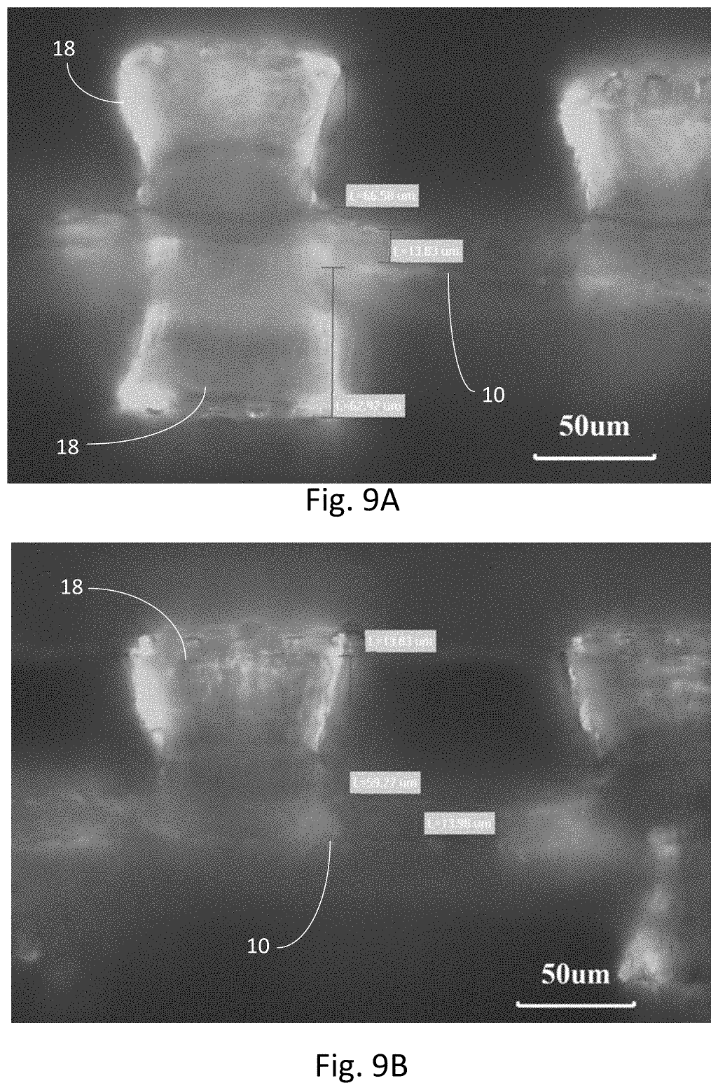

A further embodiment is fabrication of a medical surgical implant film with an initial thickness of 20 to 30 microns using PLA with 60 to 70 micron tall microfeatures on a base thickness of about 15 microns which help surgeons grip varies organs and tissues inside the body. This surgical implant film is bioresorbable and can also be placed inside the body as a barrier to prevent organs from fusing with each other during healing. Referring to FIGS. 9A and 9B, an extension of this embodiment is the fabrication of microfeatures on both sides of a PLA film having an initial thickness of 30 to 40 micron with the total height of microfeatures after forming the micro pattern of about 130 to 140 microns on a base thickness of about 14 microns. This can be used as a surgical film to prevent rubbing or relative motion between organs or tissues.

Another embodiment of the present invention is a thin TPU or silicone film with microfeatures on the outer surface of a self-expanding stent. The volume of this film is equivalent to a 50 micron initial thickness film with no microfeatures. This film can be fixed onto the surface of a self-expanding stent or other medical devices. The addition of this film on a stent would help prevent migration without tissue in-growth.

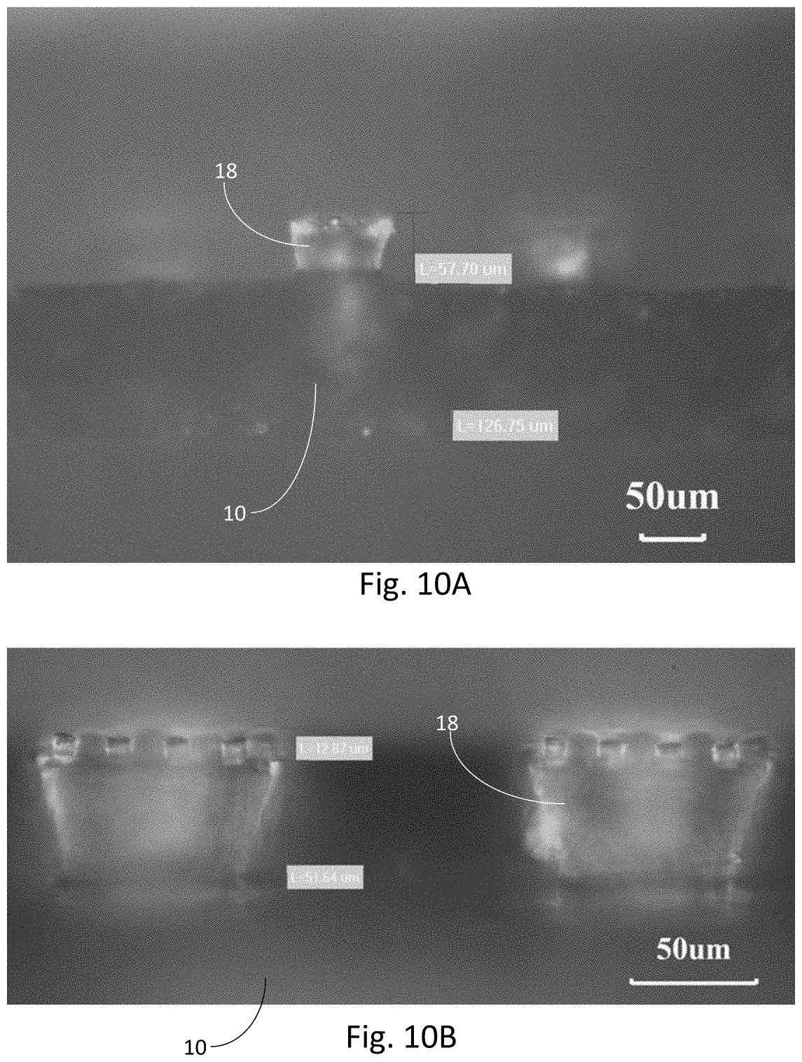

Referring to FIGS. 10A and 10B, another embodiment of the present invention is the fabrication of high grip thin TPU film (80 Shore A) with initial base thickness of about 140 to 150 microns resulting in a final base thickness of about 120 to 130 microns having microfeatures with height 60 to 70 microns. The friction testing with the micro patterned film against chicken leg muscle under wet conditions showed about 10 times increase in grip when compared to a smooth film. This film can be formed into a shape of a glove or other gripping accessory to enhance grip against wet and slippery substrate in food handling industries or graspers in medical industries or on handles and sports equipment to provide enhanced grip and performance under wet or sweaty conditions. The grip testing against human skin showed about 2 times increase in grip when compared to a smooth film. The film samples were fixed on one end to a force gauge and held by fingers on the other end. The samples were pulled until they slipped. This testing was repeated three times and grip forces were tabulated in the table below.

TABLE 5
Wet grip testing results of thin TPU film with microfeatures
against human skin and chicken leg muscle.

| | | | | | | Avg. | | Improve- |
|---|---|---|---|---|---|---|---|---|
| | | | | | | Wet | | ment in |
| | Made | | Trial | Trial | Trial | Grip | Std. | Grip |
| Pattern | in | Against | 1 | 2 | 3 | Force | Dev. | Force |
| Smooth | TPU | Chicken | 4 | 5 | 5.8 | 4.93 | 0.9 | 1.0 |
| | | leg | | | | | | |
| | | muscle | | | | | | |
| H160CP | TPU | Chicken | 47.6 | 44.8 | 43.6 | 45.33 | 2.1 | 9.2 |
| | | leg | | | | | | |
| | | muscle | | | | | | |
| Smooth | TPU | Human | 10.4 | 10.6 | 11.2 | 10.73 | 0.4 | 1.0 |
| | | Skin | | | | | | |
| H160CP | TPU | Human | 18.8 | 16 | 16.2 | 17.00 | 1.6 | 1.6 |

| | |
|---|---|
| Skin | Force in N |

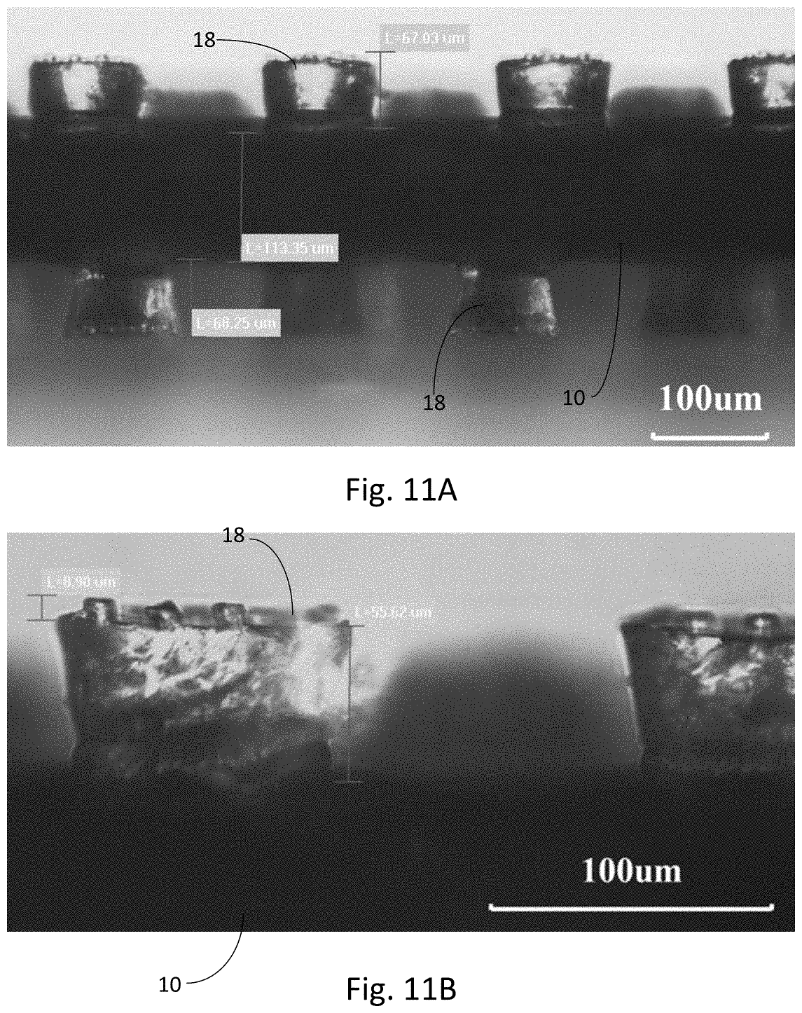

Referring to FIGS. 11A and 11B, a further embodiment of the present invention is the fabrication of high grip thin TPU film with an initial base thickness 150 to 160 microns and microfeatures on both sides of the film. The microfeatures are formed on both sides of the film with total height around 130 to 140 microns and final film base thickness around 110 to 120 microns. This film can be used to grip both the surfaces it is in contact with. For example, a glove made of thin film and microfeatures on both sides will grip human skin from the inside and wet chicken leg muscle from the outside. Thus, providing enhanced grip on both surfaces and eliminating slip.

Another aspect of the present invention is the ability of these thin PLA, TPU or silicone film to also have low coefficient of friction against hard plastic and metal surfaces. This would represent the inner surface of an introducer, catheter or other medical device through which the present invention would slide to be introduced into the body. The friction testing conducted against hard plastic and steel surface showed low friction forces when compared to smooth film in the respective materials. Delrin (acetal homopolymer or polyoxymethylene) and steel blocks were fixed at one end to a force gauge. The film samples were placed on their surface and pulled by hand until they slipped. This testing was repeated three times and grip forces were tabulated in the table below.

TABLE 3
Dry grip testing results of thin PLA film with
microfeatures against Delrin and steel.

| | | | | | | Avg. | | Reduc- |
|---|---|---|---|---|---|---|---|---|
| | | | | | | Dry | | tion in |
| | Made | | Trial | Trial | Trial | Grip | Std. | Grip |
| Pattern | in | Against | 1 | 2 | 3 | Force | Dev. | Force |
| Smooth | PLA | Delrin | 1.4 | 2.0 | 2.6 | 2.00 | 0.6 | 1.0 |
| H160CP | PLA | Delrin | 1.4 | 2.2 | 1.8 | 1.80 | 0.4 | 0.9 |
| Smooth | PLA | Steel | 2.0 | 2.4 | 2.2 | 2.20 | 0.2 | 1.0 |
| H160CP | PLA | Steel | 2.0 | 1.8 | 2.4 | 2.07 | 0.3 | 0.9 |

Force in N

TABLE 4
Dry grip testing results of thin TPU film with
microfeatures against Delrin and steel.

| | | | | | | Avg. | | Reduc- |
|---|---|---|---|---|---|---|---|---|
| | | | | | | Dry | | tion in |
| | Made | | Trial | Trial | Trial | Grip | Std. | Grip |
| Pattern | in | Against | 1 | 2 | 3 | Force | Dev. | Force |
| Smooth | TPU | Delrin | 3.6 | 3.4 | 4 | 3.67 | 0.3 | 1.0 |
| H160CP | TPU | Delrin | 3.0 | 2.4 | 2.8 | 2.73 | 0.3 | 0.7 |
| Smooth | TPU | Steel | 3.8 | 3.6 | 4 | 3.80 | 0.2 | 1.0 |
| H160CP | TPU | Steel | 3.6 | 3.2 | 3.8 | 3.53 | 0.3 | 0.9 |

Force in N

Another embodiment of the present invention is the ability of a thin film with microfeatures fabricated from an 80 Shore A or higher durometer material to grip a hard plastic or metal surface under oily conditions. This oil enhanced grip is very useful in a metal work shop to grip metal parts drenched in oil. The friction testing was conducted as described above and using the Tri-Cool Micro Drop synthetic machine oil. The PLA and TPU film samples with microfeatures showed increase in grip force when compared to a smooth film of same thickness.

TABLE 6
Oily grip testing results of thin PLA film with microfeatures
against Delrin and steel.

| | | | | | | Avg. | | Improve- |
|---|---|---|---|---|---|---|---|---|
| | | | | | | Oily | | ment in |
| | Made | | Trial | Trial | Trial | Grip | Std. | Grip |
| Pattern | in | Against | 1 | 2 | 3 | Force | Dev. | Force |
| Smooth | PLA | Delrin | 0.0 | 0.0 | 0.0 | 0.00 | 0.0 | No grip |
| H160CP | PLA | Delrin | 2.4 | 3.0 | 2.4 | 2.60 | 0.3 | 2.6 |
| Smooth | PLA | Steel | 1.0 | 1.6 | 1.2 | 1.27 | 0.3 | 1.0 |
| H160CP | PLA | Steel | 3.0 | 2.2 | 2.8 | 2.67 | 0.4 | 2.1 |

Force in N

TABLE 7
Oily grip testing results of thin TPU film with microfeatures
against Delrin and steel.

| | | | | | | Avg. | | Improve- |
|---|---|---|---|---|---|---|---|---|
| | | | | | | Oily | | ment in |
| | Made | | Trial | Trial | Trial | Grip | Std. | Grip |
| Pattern | in | Against | 1 | 2 | 3 | Force | Dev. | Force |
| Smooth | TPU | Delrin | 1.2 | 1.0 | 1.2 | 1.13 | 0.1 | 1.0 |
| H160CP | TPU | Delrin | 3.4 | 2.8 | 2.6 | 2.93 | 0.4 | 2.6 |
| Smooth | TPU | Steel | 1 | 1.2 | 1.4 | 1.20 | 0.2 | 1.0 |
| H160CP | TPU | Steel | 3.0 | 2.4 | 2.8 | 2.73 | 0.3 | 2.3 |

Force in N

The tensile strength of a TPU film was verified experimentally to show no degradation of product after the application of microfeatures. A 150-micron initial thickness TPU film with and without a micro pattern as formed according to the present invention were fixed at one end of a force gauge and pulled until failure. This testing was repeated three times and tensile forces were tabulated in the table below. The test results should that there was no significant difference in the tensile properties of the film before and after the application of microfeatures.

TABLE 8
Tensile strength testing results of thin TPU film
with and without microfeatures.

| | | | | | Avg. | |
|---|---|---|---|---|---|---|
| | Made | Trial | Trial | Trial | Tensile | Std. |
| Pattern | in | 1 | 2 | 3 | Force | Dev. |
| Smooth | TPU | 23.4 | 26.4 | 30.2 | 26.7 | 3.4 |
| H160CP | TPU | 26.2 | 30.4 | 31 | 29.2 | 2.6 |

Force in N

The compressibility of the thin film was verified theoretically by calculating the volume before and after film fabrication. Consider a 30-micron PLA sheet with 1 mm² area, its volume is 0.03 mm³. The volume of microfeatures in a 1 mm² area is calculated to be around 0.01 mm³ (with zero base thickness). Thus, maintaining constant volume, a 30-micron PLA sheet can be used to fabricate a thin film with 70-micron tall microfeatures and base thickness of 10-microns.

Apart from the above embodiments, the present invention can also be fabricated in other thermoplastics and thermosets. Polymers to which the microfeature pattern can be applied to improve grip include, but are not limited to, polylactide (PLA), acrylic, polyester, polypropylene (PP), polystyrene, nylon, epoxy, silicone, polyurethane (TPU), phenolic, polyester terephthalate (PET), polytetrafluoroethylene(PTFE), high density polyethylene (HDPE), silicone rubber, isoprene rubber, polyurethane rubbers, polyethylene (PE), polyacetal resin (POM), silicone rubber, or any other suitable rubber polymer or plastic polymer know to those skilled in the art.

Fabrication Procedure:

The present invention involves the fabrication of two-level microfeatures on a thin polymer film where the ratio of the microfeature height above the base thickness to the base film thickness is in the range of 0.3 to 4 and where the initial film thickness before forming the microfeatures is in the range of 20 to 200 um, and, where of two-level microfeatures enhance grip of thin polymer film to dry, wet or other slippery substrates. This invention will serve as a high grip film product with the ability to grip one side or both sides of a substrate.

Routes to make a desired micro pattern into a mold are described in U.S. Pat. No. 8,720,047, incorporated herein by reference in its entirety. Referring to FIG. 12, the molding process includes 1) Checking the pre-fabricated polymer film 10 as it might have thick edges or uneven thickness. Measure and confirm that the thickness is within tolerance, trim edges if required; 2) Silicone mold 26 with micro pattern is fabricated using standard lithography techniques that can be replicated by those skilled in the art; 3) Add polymer film 10 to silicone mold with pattern side using a squeegee to remove all bubbles; 4) Silicone backer 28 is fabricated using standard molding techniques that can be replicated by those skilled in the art; 5) Apply silicone backer 28 to polymer film 10; 6) Place pads 30 on both sides of the silicone mold 26 and silicone backer 28 to form a mold package to ensure even pressure and temperature distribution; 7) Place mold package 34 between aluminum press plates 32; 8) Preheat press to the required temperature, insert mold package in to the press with just enough pressure to make platens come in contact with the aluminum plates 32; 9) Increase temperature to above melting point of the polymer film and wait till the platens are heated uniformly; 10) Turn on coolant on the press and increase pressure; maintain the required pressure until the temperature of the platens drop down to room temperature; and, 11) Remove one layer at a time and be careful while demolding as the polymer film is very thin and might tear.

A volume of the polymer film before and after the addition of said two-level micro pattern is approximately the same while having microfeatures taller than the initial thickness of the polymer film.

The present invention may serve as a cover on the surface of medical devices such as stents, electrical device leads, implanted films and similar devices. It may also be used in non-medical applications such as for packaging, gloves, grip sheets, apparel or recreational goods. These are just a few of the possible applications to which the present invention can provide enhanced grip.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A thin film having microfeatures, comprising:
a polymer film having an initial thickness of 20 to 200 microns;
a two-level micro pattern formed on at least one side of said film so that said polymer film has a base thickness less than said initial thickness of said film following the addition of said two-level micro pattern; and,
a plurality of microfeatures defining said micro pattern wherein a height of said microfeatures on said film is in a range from about 0.3 to about 4 times said initial film thickness.

2. The thin film of claim 1 wherein a volume of said polymer film before and after the addition of said two-level micro pattern is approximately the same while having microfeatures taller than the initial thickness of said polymer film.

3. The thin film of claim 1 wherein said polymer film is selected from the group consisting of a thermoset and a thermoplastic.

4. The thin film of claim 3 wherein said polymer film is selected from the group consisting of polylactide (PLA), acrylic, polyester, polypropylene (PP), polystyrene, nylon, epoxy, silicone, polyurethane (TPU), phenolic, polyester terephthalate (PET), polytetrafluoroethylene(PTFE), high density polyethylene (HDPE), silicone rubber, isoprene rubber, polyurethane rubber, polyethylene (PE), polyacetal resin (POM), and silicone rubber.

5. The thin film of claim 1 wherein said polymer film has a modulus ranging from 30 Shore A to 55 Shore D.

6. The thin film of claim 1 wherein a lateral friction force of said polymer film is increased at least about 2 times compared to a smooth film of the same initial thickness when measured against wet biological tissue.

7. The thin film of claim 6 wherein a lateral friction force of said polymer film is increased about 12 times compared to a smooth film of the same initial thickness when measured against wet biological tissue.

8. The thin film of claim 7 wherein said polymer film produces a lateral friction force of up to about 60 Newtons when measured against wet biological tissue.

9. The thin film of claim 6 where a lateral friction force of said polymer film is decreased in a range of about 20% to about 80% compared to a smooth film of the same initial thickness when measured against a dry, smooth hard plastic.

10. The thin film of claim 9 where a lateral friction force of said polymer film is decreased in a range of about 20% to about 80% compared to a smooth film of the same initial thickness when measured against a dry, smooth metal surface.

11. The thin film of claim 1 wherein a lateral friction force of said polymer film is increased at least about 2 times compared to a smooth film of the same initial thickness when measured against an oily, smooth plastic surface.

12. The thin film of claim 1 wherein a lateral friction force of said polymer film is increased at least about 2 times compared to a smooth film of the same initial thickness when measured against an oily, smooth steel surface.

13. The thin film of claim 1 wherein a tensile strength of said polymer film is approximately equal to the tensile strength of a smooth film of the same initial thickness.

14. The thin film of claim 1 wherein said polymer sheet has an initial thickness of about 20 to about 30 microns and base thickness after forming of said microfeatures of about 10 to about 15 microns, and microfeatures with a height of about 70 microns.

15. The thin film of claim 1 wherein a first level of said microfeatures of said two-level micro pattern have a pitch in the range of about 190 microns to about 210 microns, a width in the range of about 90 microns to about 110 microns, and a height of about 45 microns to about 65 microns.

16. The thin film of claim 15 wherein a second level of said microfeatures are formed on said first level of said microfeatures and have a pitch in the range of about 15 microns to about 25 microns, a width in the range of about 5 microns to about 15 microns, and a height of about 5 microns to about 20 microns.

17. The thin film of claim 1 wherein said microfeatures have a contact percentage with a surface of between about 1% to about 7%.

18. A thin film having microfeatures, comprising:
a polymer film having an initial thickness of 20 to 200 microns;
a two-level micro pattern formed on a top side and a bottom side of said film so that said polymer film has a base thickness less than said initial thickness of said film following the addition of said two-level micro pattern; and,
a plurality of microfeatures defining said micro pattern wherein a ratio of a height of said microfeatures to said initial thickness of said film is greater than about 1 while maintaining a structural stability of said microfeatures to resist bending and providing increased grip against biological tissue and simultaneously providing reduced friction against dry hard plastic and metal surfaces.

19. The thin film of claim 18 wherein a volume of said polymer film before and after the addition of said two-level micro pattern is approximately the same while having microfeatures taller than the initial thickness of said polymer film.

20. A method of forming microfeatures onto a thin film comprising the steps of:
providing a silicone mold with a desired micro pattern
applying a polymer film to a pattern side of said silicone mold;
applying a silicone backer over said polymer film on said silicone mold;
placing pads on said silicone mold and said silicone backer to form a mold package to facilitate even pressure and temperature distribution;
placing said mold package between heated press plates;
applying pressure and temperature to reach a melting point of said polymer film;
maintaining pressure while cooling to room temperature;
removing said polymer film from said mold package;
wherein said polymer film has an initial thickness of 20 to 200 microns;
wherein a two-level micro pattern is formed on at least one side of said film so that said polymer film has a base thickness less than said initial thickness of said film following the addition of said two-level micro pattern; and,
wherein a plurality of microfeatures defining said micro pattern have a height in a range from about 0.3 to about 4 times said initial film thickness.
